(19) United States
(12) Patent Application Publication
(10) Pub. No.: US 2005/0212279 A1
(43) Pub. Date: Sep. 29, 2005

(54) Portable motorcycle/ ATV towing system

(76) Inventor: Nino S. Volpe, Melville, NY (US)

Correspondence Address: NINO S. VOLPE, 46 BEAUMONT DRIVE, MELVILLE, NY, 11747, US

(21) Appl. No.: 11/012,537

(22) Filed: Dec. 15, 2004

Related U.S. Application Data
(60) Provisional application No. 60/531,515, filed on Dec. 19, 2003.

(51) Int. Cl. B60P 3/06

(52) U.S. Cl. 280/769

(57) ABSTRACT

This Portable Motorcycle/ATV Towing System is a rear wheel only lifts system that provides a safe and precise towing arrangement for most light to heavy motorcycle cruisers. The exclusive rear wheel lift expanding hatch principle protects the drive train from damage due to possible lubrication depravation. The unit is designed to be universal and not exclusive to one type or manufacturer of motorcycles or ATVs. Even though the system is of a heavy duty nature it remains portable. Each component disassembles easily in consecutive order by simply removing a series of assembly pins and a primary king pin. There are six major components, all designed to fit in a vehicle storage container as opposed to having to keep a trailer constantly attached to the vehicle. The highlights of this system are its portability, stability while towing, and ease in loading with the winch system. As of this writing, a working prototype has been in existence for the past year. Repetitive road testing has solidified the systems purpose and integrity.

### BACKGROUND OF THE INVENTION

The following text describes the scope, application and mechanical description of a portable, heavy duty motorcycle towing system. The system is designed to be easily assembled and disassembled within a few minutes and stored in a vehicle storage container.

Specific for use in conjunction with a class 3 to class 5 receiver and applicable to an SUV, pickup truck or larger passenger car, this system will provide safe and precise towing performance of most light to heavy motorcycle/ATV requirements.

Unique to this system is its rear wheel lift only application. The rear lift principle eliminates all possible drive train rotational problems inherent to towing, i.e.: lubrication of the final drive being primary, wear, drive chain vibration under no load conditions and mileage accumulation. This philosophy parallels the automotive and truck community, to always lift the wheels while towing or risk major drive train problems, the transmission being primary. In addition, the rear lift and securing system maintains and dictates an in line principle from the pivoting kingpin at the receiver to the front wheel of the motorcycle in contact with the road surface at the rear. We are only asking the motorcycle's front wheel to roll in reverse. Since there is no rider, the load at that point is minimal. There are a few front wheel lift systems on the market. Unlike my rear lift principle, these systems, for the most part, depend on the motorcycles steering system as the pivot/fulcrum. With the front wheel lifted, the exaggerated geometric loading of the front fork and triple tree will eventually cause premature damage to the motorcycle and erratic handling during towing. In addition, since the rear wheel is in contact and rotating on the road, the fore mentioned damaging conditions could occur.

The exclusive expanding hatch principle, utilizing the conventional 4 ton hydraulic bottle jack, enables the lifting requirements of the system to go from a vehicle bumper level parallel to a rotational lifting function 2 to 2½ feet behind the rear bumper. (See FIG. 2 and FIG. 3) This facilitates the opening and closing of either a rear hatch on an SUV or the rear tailgate of a pickup with a motorcycle in the lifted position.

Pre-determined lean angles of the motorcycle are dictated and controlled by the system's pivot fulcrum positive caster angle. This provides simulation of a ridden cycle's stability and positive tracking, although in reverse. With a 10 degree setting, (positive caster angle) and the cycle on center, this feature will provide a parabolic lean angle of zero while going straight ahead to a maximum of 10 degrees right or left while cornering. Handle bars are locked, while towing, via ratchet tie straps and locking clamp at handle bar handgrips in a straight ahead configuration.

### SUMMARY

This towing system FIG. 1 can be described as a 2 inch towing receiver system consisting of six detachable components that utilize a 1 by 12 inch king pin pivot and six steel assemble pins. The majority of all pieces are of heavy steel construction. The lifting mechanism is a conventional 4 ton bottle jack mounted on a pivoting base. Item 1 of FIG. 1 is the tow hitch receiver/king pin fulcrum pivot welded assembly. Item 3 is the primary hatch/hydraulic jack mounting plate secured to the receiver by the kingpin, 2. The rear lifting hatch 6 is secured to the primary pump plate by a ¾ by 10 inch steel assemble pin 4. This pin 4 provides the fulcrum during the lift process of the hydraulic jack. The lifting element of the jack is centered on a recessed boss welded on the inside face of the rear hatch. Attached to the rear hatch are both a conventional 600 lb. loading winch 8 with hand crank, and a transverse tubular steel link 9 incorporating housed heavy duty automotive suspension bushings welded in a perpendicular fashion at each end of the steel tube. Both of these bushings are fitted with two conventional heavy duty ½×4 inch chrome eye bolts 10. These eye bolts 10, in conjunction with a trio of guide rollers, (two tapered vertical and one horizontal 11) provide the guide path for the loading medium of two 1500 lb. loading straps 12 controlled by the winch 8. This roller trio 11 is attached via a horizontal bracket and welded to the tire cradle lifting arm 13 at its top. Below this bracket is a welded transverse tubular bushing. The rear hatch plate incorporates a pair of welded tubular bushings at its top. The lifting arm sleeve is positioned between the hatch bushings and secured with a ¾×10 inch assembly pin 7. The final two components of the system are the tire cradle 15 and cradle mounting block 14 that attaches with two ½×4 inch assembly pins and a ⅝×4 inch bolt (not shown), securing the mounting block to the lifting arm. Note, in FIG. 1 items 16 and 17 illustrate the rear wheel of the motorcycle and the tie down ratchet and strap securing the cycle to the tire cradle.

This system utilizes three commercially available components to enable and enhance the unique expanding hatch lifting and towing principle that is claimed. The winch assemble performs the loading function, the 4 ton bottle jack performs the hydraulic lifting task and a heavy duty 10,000 lb. rated ratcheted 2 inch strap performs the circumferential rear tire/wheel securing requirement to the tire cradle. In addition, an assortment of 1 inch ratchet tie downs are required for securing the handle bars and handling the vector loading and tie down specific to a variety of motorcycles/ATVs. Note, this system is designed as a universal towing system, not specific to one type of manufacturer of motorcycles or ATVs.

While the invention has been particularly shown and described with reference to a preferred component selection, it will be understood by those skilled in the art that various modifications in form and detail may be made therein without departing from the scope or spirit of the invention. Accordingly, modifications, such as those suggested above, but not limited thereto are to be considered within the scope of the invention and the appended claims.

### BRIEF DESCRIPTION OF THE DRAWINGS

The above and other features and objects of the invention will be better understood from the following detailed description of the typical components illustrated in the accompanying drawings, in which:

FIG. 1 is a complete assembled view of the Portable Motorcycle/ATV towing system complete with loaded motorcycle.

FIG. 2 is a complete side view of the towing system showing the apparatus in the lowered or down position.

FIG. 3 is a complete side view of the towing system showing the apparatus in the lifted or up position.

FIG. 4 is a perspective view of the receiver/kingpin fulcrum pivot assemble with kingpin and receiver lock clevis pin.

FIG. 5 is an exploded view of the primary pump plate including front pivoting plate, hydraulic jack, pivot base for jack with mounting brackets and assembly pin.

FIG. 6 is a partially exploded view of the rear lift portion of the expanding hatch assembly including the two “L” shape plates that are secured together by two bolts, the transverse tubular stabilizer complete with housed bushings, eye bolts, assemble pin and conventional 600 lb. loading winch.

FIG. 7 is an exploded reverse view of FIG. 6 showing the complete disassembly of the two “L” shaped plates, transverse tubular stabilizer, housed bushings and eye bolts.

FIG. 8 is an exploded view of the tire cradle lifting arm, showing the disassembly of the twin tapered vertical guide rollers, one cylindrical horizontal guide roller, tire cradle mounting block, twin assembly pins and mounting bolt.

FIG. 9 is a perspective view of an assembled FIG. 8 with related assembly pin.

FIG. 10 is a perspective view of an assembled FIG. 8 in reverse.

FIG. 11 is a perspective view of the tire cradle and tire cradle mounting block.

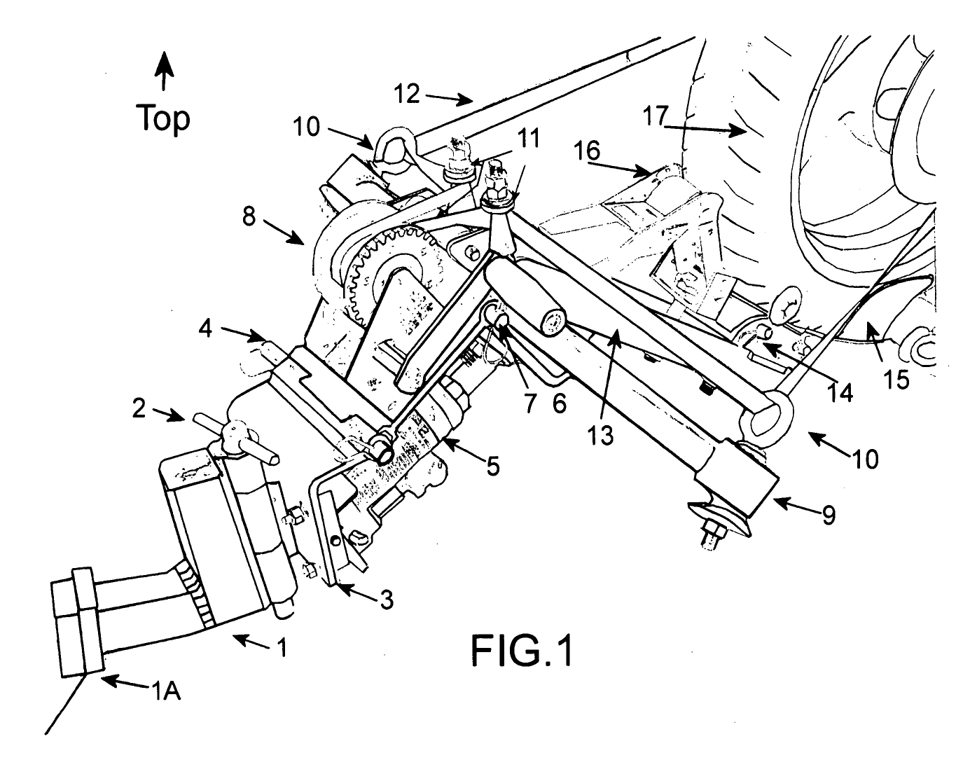

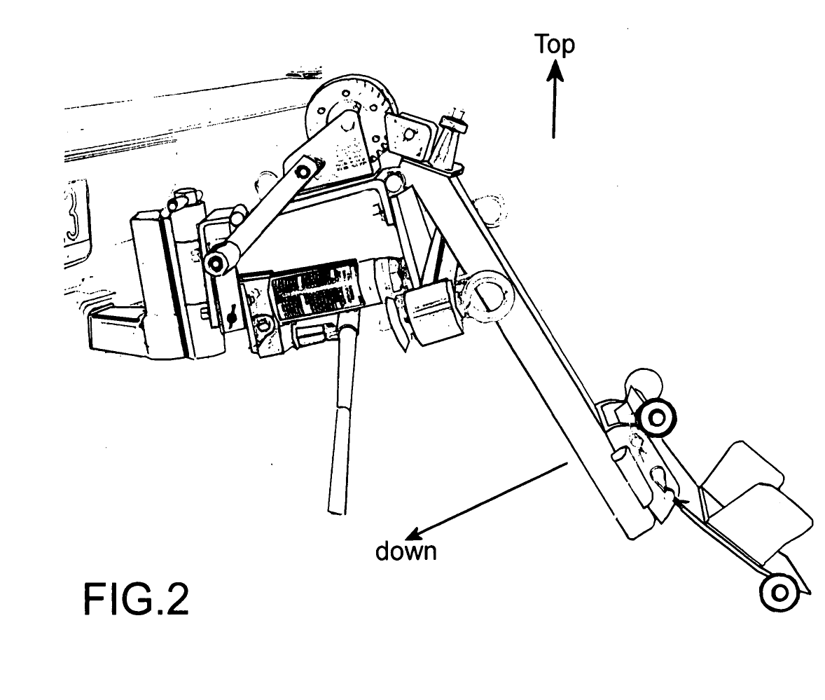

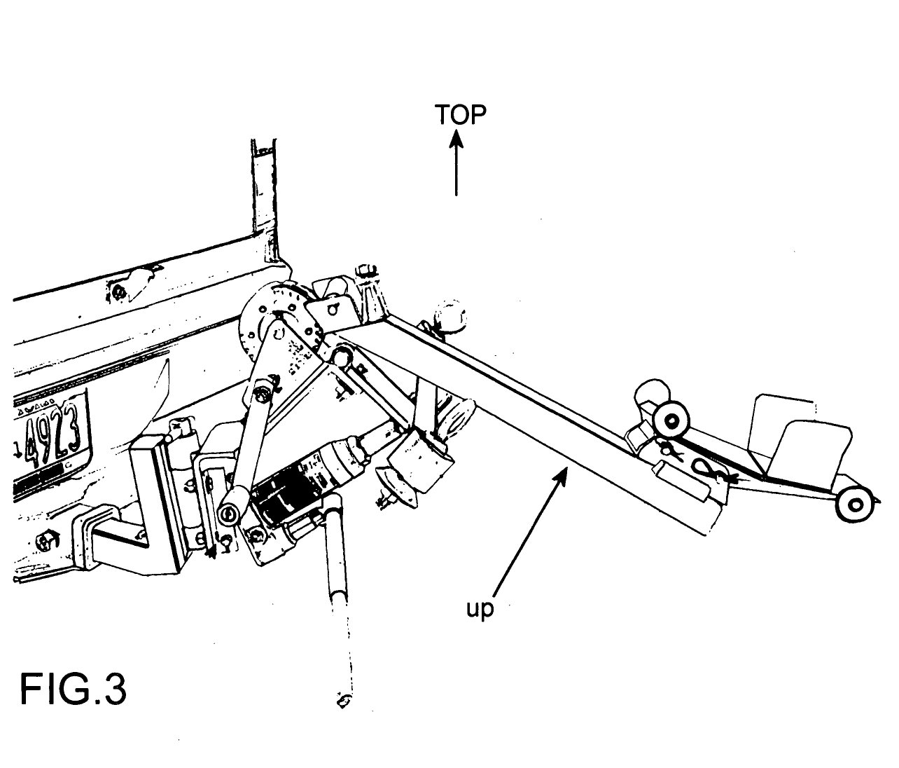

### DETAILED DESCRIPTION OF THE INVENTION

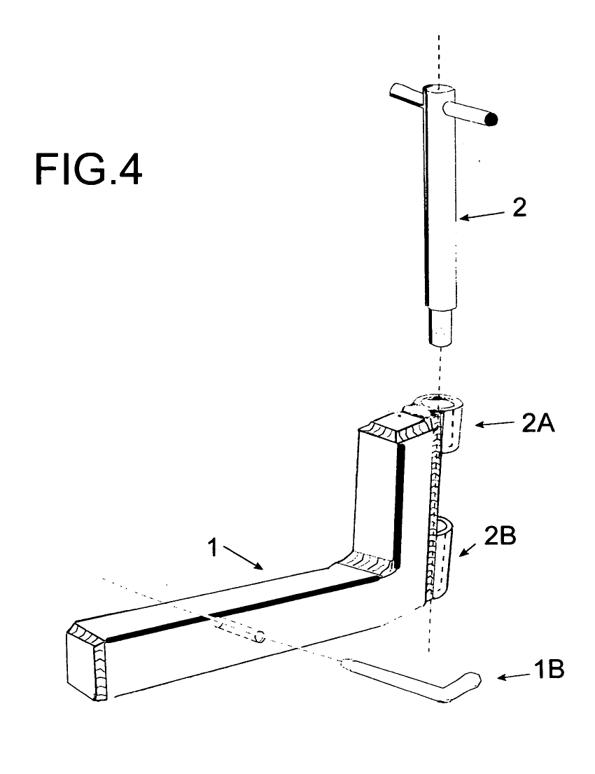

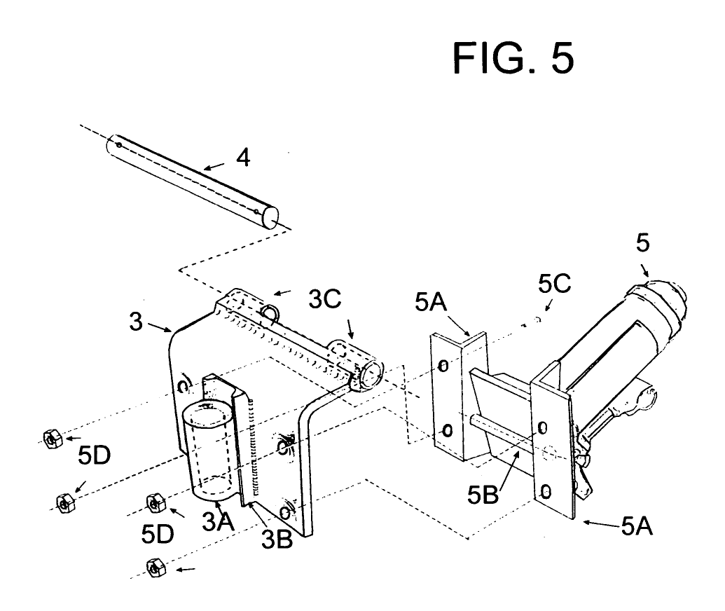

Referring first to FIG. 4, the primary assembly component is the two inch square receiver/kingpin fulcrum pivot assemble, 1. The assembly is comprised of a heavy 2 inch×18 inch square tube with a wall dimension of 0.250 inch that is affixed/welded in an “L” shape configuration to a second square tube of a 2 inch×10 inch×0.250 inch dimension. The welded tube combination distracts 10 degrees from the true perpendicular of 90 degrees with the upper or proud end of the vertical tube to be tilted forward toward the entry end of the horizontal tube than the base of the vertical tube is to the entry portion of the horizontal. Entry indicates entry to the towing vehicles receiver assembly. This horizontal tube is also cross bored at a ⅝ hole dimension to facilitate the entry of the conventional lock pin 1B to the towing vehicle's receiver. This positioned vertical tube now becomes the mounting foundation of the two vertically aligned heavy walled support bushings, 2A and 2B that align the vertical pivot king pin, 2. The upper support bushing 2A is of a 1⅝ inch×2 inch cylindrical configuration. The lower 2B is of a 1⅝ and 3 inch dimension. Both have a 1 inch bore and a wall dimension of 5/16 of an inch. These cylindrical configurations are jig aligned and welded to the rear face of the vertical tube. This now provides a mounting foundation for the attachment of the primary pump plate FIG. 5 via king pin 2. This configuration allows for a mounting position of 10 degrees positive caster angle of the pivot fulcrum at the kingpin. Variations in caster angle may be used in production units as an adjustment in tracking characteristics during towing.

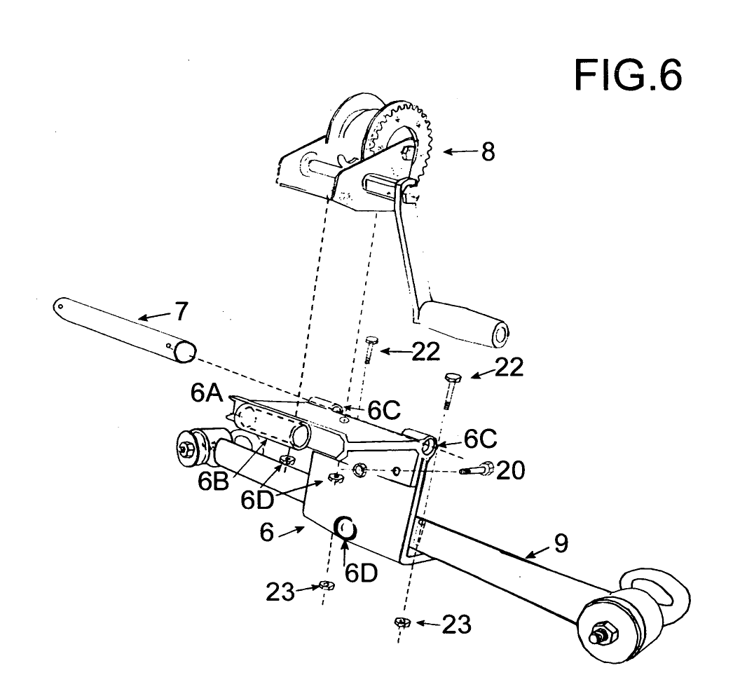

Referring to FIG. 5 is the primary pump plate including a front pivoting plate, hydraulic jack, pivot base for jack with mounting brackets and assembly pin. The expanding hatch design of this system uses three identical heavy duty ‘L’ shaped steel plates of a 5 inch×6½×⅜ inch thick dimension with a 2 inch fold forming the short portion of the ‘L’. These three plates are the basis of my expanding hatch lifting principle, when each plate is individually configured with a variation of welded bushings and attachments. The first component is the primary pump plate. This plate utilizes a trio of heavy duty welded bushings in the following manner: A 1⅝×3 inch bushing 3A, is vertically aligned to the front face of plate 3. The bushing is first centered on a 4 inch×1½ inch channel steel with a 1/2 inch side wall 3B and welded. This now provides the precise mounting medium between the receiver 1, FIG. 4, the kingpin 2, and the primary plate 3, FIG. 5. This steel channel is used as both an alignment and welding medium in securing the bushing by providing more of an effective welding surface. This channel/bushing procedure is next performed in the same manner at the rear of the short upper fold with two smaller bushings at 3C in a horizontal manner. Once positioned at opposite ends in the steel channel, this bushing/channel assemble is then perpendicularly aligned at the trailing edge of plate 3 and welded across on the upper and lower seams of the channel. This bushing/plate assembly 3 and 3C, provides for the attachment and fulcrum via assembly pin 4 of the rear lift portion of the expanding hatch. This will be discussed later in FIG. 6. The remaining sub assembly of FIG. 5 is the bottle jack and mounting brackets 5. This bracket combination consists of two 4×1 inch sections of angle steel 5 A, a 3×4×⅛ inch steel plate and a ½ inch×5 inch hardened steel rod 5B welded together to form a pivot base for the bottle jack. The jack is bolted to this base using two ¼×20×1 inch machine bolts (not shown). The angle steel mounting brackets are drilled symmetrically in four places and attached to the primary plate via four mounting bolts (1 shown) and nuts 5C and 5D respectively. One, 1/2 inch hole is drilled at 90 degrees in the lower portion of each bracket to support the pivot base of the bottle jack.

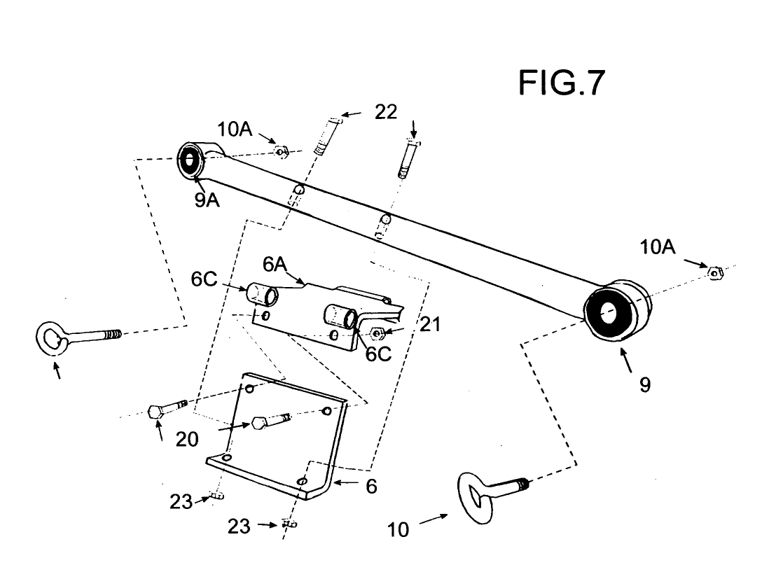

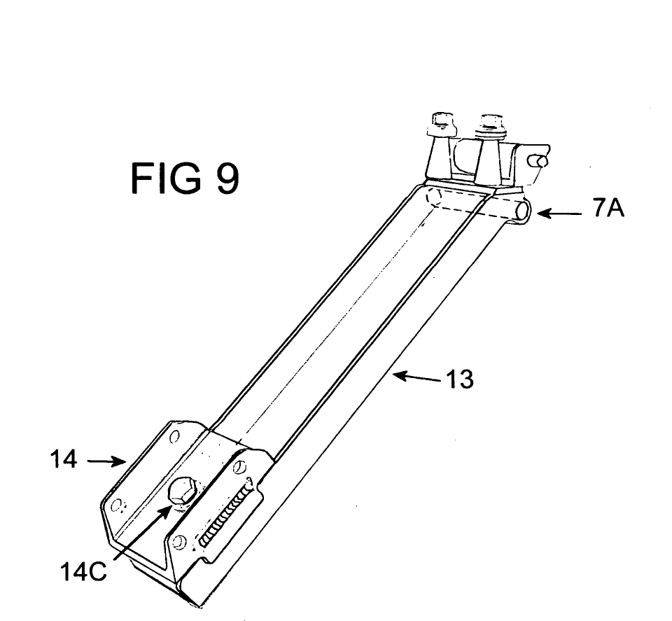

FIG. 6 and FIG. 7 refers to the rear lift portion of the expanding hatch assemble including the two ‘L’ Shaped plates, the transverse tubular stabilizer complete with housed bushings, eye bolts, assembly pin and conventional 600 lb. winch. This rear lift element is comprised of the remaining two ‘L’ plates and the way in which they are configured. Top plate 6A is configured with a single tubular bushing, ⅛×3 inch, centered on a 6 inch section of channel steel, and welded in a perpendicular fashion to the leading edge of top plate 6A forming bushing support 6B. Bushing 6B attaches to twin bushings 3C on primary pump plate 3 utilizing assembly pin 4, FIG. 5 providing the lifting fulcrum point of the expanding hatch assembly. Plate 6A is then configured with two support bushings 6C at the rear of the plate. These bushings are positioned parallel to bushing 6B, but are positioned on each side of plate 6A on the opposite side. At that point, plate 6A is a radius arc with the short segment of the ‘L’ pointing downward. At the apex of this radius, bushings 6C are aligned tangent to this radius and jig welded on both sides. This bushing configuration is now the platform for the attachment of the tire cradle lifting arm 13, FIG. 9 once secured with assembly pin 7. Item 13 FIG. 9 will be described in a later paragraph. Top plate 6A is now top drilled to accept the two bolts required in the mounting of the 600 lb. winch 8 with hardware 6D. Remaining ‘L’ plate 6, now attaches in a vertical manner to the short vertical segment of plate 6A. These two plates are secured with two ½×13×2 inch machine bolts and nuts 20 and 21. Plate 6 is configured with one 1½ inch diameter circular and raised welded seat 6D that is centered and positioned in the lower portion of plate 6. This provides the lifting platform for the hydraulic jack 5. Plates 3, 6 and 6A, in conjunction with the mounted pivoting hydraulic jack, are the nucleus of the fore mentioned expanding hatch principle. Attached to the short lower ledge of plate 6, FIG. 7 is the transverse tubular steel link 9, incorporating housed heavy duty automotive suspension bushings 9A welded perpendicular to the tube at each end. These rubber bushings support the two 1/2 inch×4 inch chrome eyebolts 10 and 10A. The tubular link is secured by two 1/2 inch×3 inch bolts and nuts, 22 and 23.

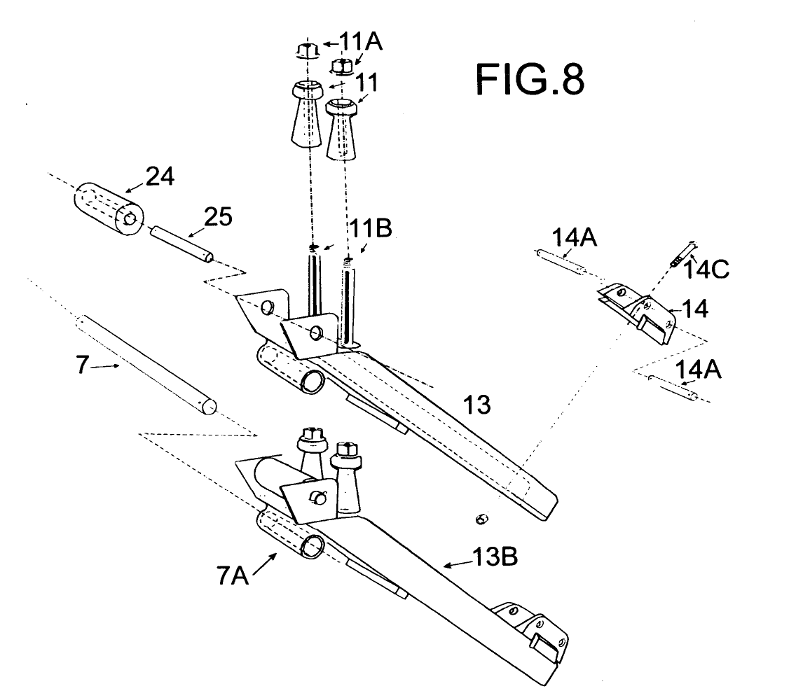

Referring to FIG. 8 and FIG. 9, is the tire cradle lifting arm assembly, 13. The backbone of this assembly is the arm. Fabricated out of heavy 1½ inch×4 inch×22 inch steel channel with a wall dimension of 3/8 inch, this piece is the basic lifting element with a few modifications. Placed at the top of the arm is a 4×4×¼ inch mounting plate that supports two vertical ½×4 inch taper roller guide studs that are vertically aligned and welded to the plate 11B. Twin taper rollers 11 are attached and secured with lock nuts 11A. Behind these rollers is one horizontal 1½×4 inch cylindrical roller 24, and vertically eared mounting bracket that is welded at the rear of the 4×4 plate. Roller 24 is attached via pin 25. Below the mounting bracket and mounted transversely is a 1⅛×4 inch tubular steel bushing. This bushing is positioned on the upper underside of the lifting arm, squared to assure perpendicularity, and jig welded at that point, 7A. This provides for the rear hatch 6A attachment at 6C to lift arm bushing 7A via assembly pin 7. The tire cradle mounting block 14 is best depicted in FIG. 9. Fabricated from a length of 1½×4×6 inch channel steel (same stock as lifting arm), symmetrically cross drilled for mounting purposes, diagonally center drilled 5/8 inch bore for mounting, and adding edge guide blocks on both sides for tracking above and for adjustment on lift arm and secured to lift arm using a ⅝×3 inch machine bolt item 14C and nut 14D, FIG. 8.

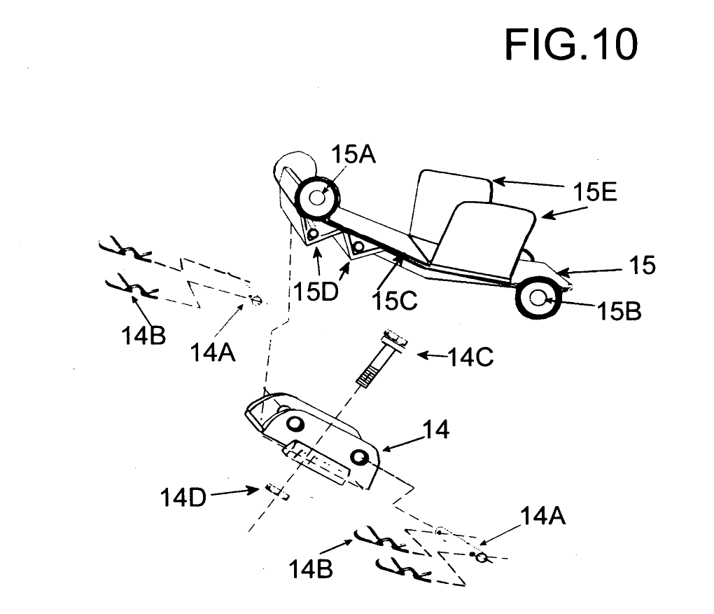

FIG. 10 is the tire cradle 15 and mounting block 14. The tire cradle on the prototype is of a preset width dimension. The bed of the unit is made from tow pieces of 8×18 inch× 1/8 inch flat steel that is layered together, jig arced at an 11 inch radius and seam welded to maintain the configuration 15C. AT the front and on the underside are two 1½×1½×8 inch pieces of angle steel 15D that are transversely mounted side by side and welded to the underside of the platform. These two angle steel pieces provide the transverse tubular guides for attaching the tire cradle to the cradle mounting block 14, via the two ½ inch assembly pins 14A. The pins are secured with four lock clips 14B. Reference 15A and 15B (one side shown) are four heavy, circular washers fitted with threaded, ½×13 coarse inserts and welded vertically to two transverse 1½×1½×8 inch angle steel pieces. These two welded configurations are aligned transversely at the top forward position and the rear lower position and jug welded in place. These four locations provide for the mounting and tie down locations via heavy duty ½ inch eye bolts as necessary. 15E are two vertical tire guides of a 4×4×⅛ inch dimension and welded upright at a 15 degree outward profile. Both guides are rounded at the four upper corners.

While the invention has been particularly shown and described with reference to a preferred component selection, it will be understood by those skilled in the art that various modifications in form and detail may be made therein without departing from the scope or spirit of the invention. Accordingly, modifications, such as those suggested above, but not limited thereto are to be considered within the scope of the invention and the appended claims.

1) A rear wheel lift system specific to class 3 and 5 receiver that utilizes a unique expanding hatch hydraulic lifting system.

2) A rear wheel lift system that remains close to a bumper level parallel and allows for tow vehicle access of rear hatch or tailgate when motorcycle is in raised position.

3) A lift system that lifts in a rotational motion, moving up and away from the tow vehicle during the lift process.

4) A rear wheel lift system that uses a kingpin pivot and positive caster settings to maintain a zero on line setting and pre-determined parabolic lean angles when turning right or left.

5) A rear wheel lift principle that uses a transverse towing stabilizer with ratchet tie downs.

6) A rear wheel lift system that utilizes a hand crank winch for loading purposes.

7) An expanding hatch system that maximizes rotational torque stability.

8) A rear wheel towing system that does not impose exaggerated geometric loads on the motorcycle's steering and triple tree system.
